(19) United States
(12) Patent Application Publication
(10) Pub. No.: US 2026/0338563 A1
(43) Pub. Date: Oct. 29, 2026

(54) APPARATUS AND METHOD FOR GENERATING DRIVING ROUTES

(71) Applicants: HYUNDAI MOTOR COMPANY, Seoul (KR); KIA CORPORATION, Seoul (KR)

(72) Inventors: Ji Hye Lee, Hwaseong-si (KR); Jong Taek Han, Hwaseong-si (KR); Kun Hee Ryu, Hwaseong-si (KR); Jae Chang Kook, Hwaseong-si (KR); Jin Sung Kim, Hwaseong-si (KR)

(73) Assignees: HYUNDAI MOTOR COMPANY, Seoul (KR); KIA CORPORATION, Seoul (KR)

(21) Appl. No.: 19/326,599

(22) Filed: Sep. 11, 2025

(30) Foreign Application Priority Data
Apr. 23, 2025 (KR) 10-2025-0053217

(51) Int. Cl. G01C 21/34; G01C 21/36

(52) U.S. Cl. CPC G01C 21/3446; G01C 21/3602

(57) ABSTRACT

An apparatus for generating driving routes includes a memory configured to store a virtual driver agent and a diffusion model. The apparatus also includes a processor configured to train the virtual driver agent to output driving routes respectively corresponding to pre-defined driving levels for a given road and train the diffusion model based on distribution of the driving routes for respective driving levels output by the trained driver agent. The processor is also configured to input information about a route segment of the road where driving data is to be generated, information about a plurality of pre-configured waypoints to be passed within the route segment, and initial noise corresponding to a length of the driving data to the trained diffusion model and generate driving data corresponding to the length using the trained diffusion model.

### CROSS-REFERENCE TO RELATED APPLICATION(S)

The present application claims the benefit of and priority to Korean Patent Application No. 10-2025-0053217, filed on Apr. 23, 2025, the entire contents of which are hereby incorporated herein by reference.

### BACKGROUND

### 1. Technical Field

The present disclosure relates to an apparatus and a method for generating a driving route having various driving trajectories for respective driving levels.

### 2. Description of Related Art

With the advancement of the automotive industry, vehicle driving performance has improved, and interest in motorsports has increased, thereby raising the popularity of circuit (track) racing. Accordingly, various drivers with different driving skills are seeking guidance to improve their driving capabilities, and to this end, a virtual track instructor service may be considered to analyze driving data, based on artificial intelligence (AI) technology, and provide appropriate guidance depending on each driver's level.

In order to determine the driving level of each driver, based on driving data, and to provide guidance for enhancing the driving skill to the next level, a virtual track instructor model may learn various driving data having diverse driving trajectories for individual driving levels. To learn such a wide range of driving data, various driving data may be obtained. To obtain the driving data, an autonomous driving simulator, that provides a virtual environment for verifying vehicle autonomous driving, driving performance evaluation, and the like, may be. A general autonomous driving simulator may perform a function of generating an optimal driving route by precisely replicating the vehicle model, movement of surrounding vehicles, road environment, and the like.

However, when assuming a track environment, the driving routes generated by such autonomous driving simulators typically converge to a record line aimed at achieving the best lap time. Therefore, the driving route provided by the autonomous driving simulator is difficult to provide differences depending on each driver's driving level and to reflect diverse driving strategies (for example, combinations of Out/In courses during cornering). As a result, it is difficult to obtain diverse data for training the virtual track instructor model using a general autonomous driving simulator.

The foregoing described as the background art is intended merely to aid in the understanding of the background of the present disclosure, and should not be construed as meaning that the present disclosure falls within the purview of the related art already known to those having ordinary skill in the art.

### SUMMARY

Aspects of the present disclosure provide a method and an apparatus for generating a driving route having various driving trajectories for respective driving levels.

The technical objects of the present disclosure are not limited to the technical objects mentioned above. Other technical objects not mentioned herein should be more clearly understood by those having ordinary skill in the art to which the present disclosure pertains from the following description.

According to an aspect of the present disclosure, a driving route generation device is provided. The driving route generation device includes a memory configured to store a virtual driver agent and a diffusion model. The driving route generation device also includes a processor configured to train the virtual driver agent to output driving routes respectively corresponding to pre-defined driving levels for a given road. The processor is also configured to train the diffusion model based on distribution of the driving routes for respective driving levels output by the trained virtual driver agent. The processor is further configured to input information related to a route segment of the road where driving data is to be generated, information related to a plurality of pre-configured waypoints to be passed within the route segment, and initial noise corresponding to a length of the driving data to the trained diffusion model. The processor is further configured to generate, using the trained diffusion model, driving data corresponding to the length.

In an embodiment, the virtual driver agent may include a training algorithm based on reinforcement learning. The training algorithm may train a policy such that the virtual driver agent improves a reward while interacting with the road.

In an embodiment, the virtual driver agent may determine the reward based on

$${r}_{t} = \{ \begin{matrix}- c & ( if crashed ) \\ - ( {e}_{θ} {p}_{θ} + {e}_{c} {p}_{c} ) + {Δθ}_{t} & ( otherwise )\end{matrix}$$

wherein: c is a predetermined constant; e_{θ} is a distance from a current location of the virtual driver agent to a current target point configured according to a policy determined through the training algorithm; pe is a weight for a value of e_{θ}; e_{c} is a vertical distance between a location after the virtual driver agent performs an action according to the policy determined through the training algorithm and a centerline of the road; pc is a weight for a value of e_{c}; and Δθₜ is a distance by which the virtual driver agent travels from a reference location to a target location. The travelled distance may have a positive value based on a vehicle moving forward and a negative value based on a vehicle moving backward in a reference coordinate system.

In an embodiment, the policy may determine actions to be performed by the virtual driver agent for respective driving situations.

In an embodiment, the trained virtual driver agent may receive, as an input, distances to boundaries of a driving road or obstacles determined by sensors provided in a vehicle and a location, speed, angular velocity, and steering angle of the vehicle, and may output the distribution of the driving routes determined for respective driving levels based on the input.

In an embodiment, the distribution of the driving routes for respective driving levels may be a multi-dimensional vector in a form of a matrix corresponding to a plurality of actions performed by the trained virtual driver agent for respective driving situations.

In an embodiment, the diffusion model may divide information related to the distribution of the driving routes for respective driving levels into partial data of a certain size using a sliding window technique and may learn the partial data.

In an embodiment, the diffusion model may learn the distribution of the driving routes for respective driving levels without initial conditions and perform denoising and data restoration through forward and reverse diffusion processes.

In an embodiment, the diffusion model may further include a classifier configured to use gradients of a pre-trained neural network to convert driving data output by the diffusion model into human-drivable data. The classifier may be configured to operate as a guidance function of generating feedback for output driving data of the diffusion model.

In an embodiment, the plurality of pre-configured waypoints may include one or more of an entry waypoint of the driving route within the route segment, an apex waypoint indicating a turning point where a driving direction changes on the driving route, or an exit waypoint indicating an end point of the driving route.

According to another aspect of the present disclosure, a method for generating driving routes is provided. The method includes training, by a processor, a virtual driver agent to output driving routes respectively corresponding to pre-defined driving levels. The method also includes training, by the processor, a diffusion model based on distribution of the driving routes for respective driving levels output by the trained driver agent. The method additionally includes inputting, by the processor, information related to a route segment of a road where driving data is to be generated, information related to a plurality of pre-configured waypoints to be passed within the route segment, and initial noise corresponding to a length of the driving data to the trained diffusion model. The method further includes generating, using the trained diffusion model, driving data corresponding to the length.

In an embodiment, the virtual driver agent may include a training algorithm based on reinforcement learning. Training the virtual driver agent may include using the training algorithm to train a policy such that the virtual driver agent improves a reward while interacting with the road.

In an embodiment, training the virtual driver agent may include determining the reward based on

$${r}_{t} = \{ \begin{matrix}- c & ( if crashed ) \\ - ( {e}_{θ} {p}_{θ} + {e}_{c} {p}_{c} ) + {Δθ}_{t} & ( otherwise )\end{matrix} ,$$

wherein: c is a predetermined constant; e_{θ} is a distance from a current location of the virtual driver agent to a current target point configured according to a policy determined through the training algorithm; pe is a weight for a value of e_{θ}; e_{c} is a vertical distance between a location after the virtual driver agent performs an action according to the policy determined through the training algorithm and a centerline of the road; p_{c} is a weight for a value of e_{c}; and Δθₜ is a distance by which the virtual driver agent travels from a reference location to a target location. The travelled distance has a positive value based on a vehicle moving forward and a negative value based on a vehicle moving backward.

In an embodiment, the policy may determine actions to be performed by the virtual driver agent for respective driving situations.

In an embodiment, the method may further include inputting, by the processor, into the trained virtual driver agent, distances to boundaries of a driving road or obstacles determined by sensors provided in a vehicle and a location, speed, angular velocity, and steering angle of the vehicle to obtain the distribution of the driving routes for respective driving levels. The method may also include outputting, by the processor, the distribution of the driving routes obtained for the respective driving levels.

In an embodiment, the distribution of the driving routes for respective driving levels may be a multi-dimensional vector in a form of a matrix corresponding to a plurality of actions performed by the trained virtual driver agent for respective driving situations.

In an embodiment, training the diffusion model may include dividing information related to the distribution of the driving routes for respective driving levels into partial data of a certain size using a sliding window technique and training the diffusion model based on the partial data.

In an embodiment, training the diffusion model may include training the distribution of the driving routes for driving levels without initial conditions, including performing denoising and data restoration through forward and reverse diffusion processes.

In an embodiment, the method may further include converting, by a classifier of the diffusion model using gradients of a pre-trained neural network, driving data output by the diffusion model into human-drivable data. The classifier may operate as a guidance function of generating feedback for output driving data of the diffusion model.

In an embodiment, the plurality of waypoints may include one or more of an entry waypoint of a driving route within the route segment, an apex waypoint indicating a turning point where a driving direction changes on the driving route, or an exit waypoint indicating an end point of the driving route.

According to at least one embodiment of the present disclosure, the driving route generation apparatus and method are capable of generating driving data having various trajectories and cornering strategies by receiving one or more waypoints using a diffusion model trained on the distribution of driving routes for respective driving levels.

Advantageous effects obtainable from the present disclosure may not be limited to the above-mentioned effects. Other effects which are not mentioned herein should be more clearly understood from the following descriptions by those having ordinary skill in the art to which the present disclosure pertains.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 is a block diagram illustrating a configuration of a driving route generation apparatus according to an embodiment of the present disclosure;

FIG. 2 illustrates an example of a process in which a driving route generation apparatus generates driving data according to an embodiment of the present disclosure;

FIG. 3 illustrates an example of a process in which a virtual driver agent is trained according to an embodiment of the present disclosure;

FIG. 4 illustrates an example of a form of data input to a trained virtual driver agent and a form of data output based thereon according to an embodiment of the present disclosure;

FIGS. 5 and 6 illustrate a method in which a virtual driver agent generates driving data corresponding to a driving level in an embodiment of the present disclosure;

FIG. 7 illustrates an example of a form in which information about the distribution of driving routes for respective driving levels is divided using a sliding window technique according to an embodiment of the present disclosure;

FIG. 8 illustrates training data learned during training of a diffusion model and data restored based thereon according to an embodiment of the present disclosure;

FIG. 9 illustrates an example of a forward diffusion process during training of a diffusion model according to an embodiment of the present disclosure;

FIG. 10 illustrates an example of a reverse diffusion process during training of a d diffusion model according to an embodiment of the present disclosure;

FIG. 11 illustrates an example of a form of data input to a driving route generation apparatus according to an embodiment of the present disclosure; and

FIG. 12 illustrates an example of a process of generating driving data according to an embodiment of the present disclosure.

### DETAILED DESCRIPTION

Hereinafter, embodiments of the present disclosure are described in detail with reference to the accompanying drawings. The same or similar elements are given the same and similar reference numerals regardless of the figure numbers, and duplicate descriptions thereof have been omitted. The terms “module” and “unit” used for the elements in the following description are given or interchangeably used in consideration of only the ease of explanation, and do not have distinct meanings or roles by themselves. Furthermore, in describing the embodiments set forth herein, where it was determined that a detailed description of known relevant technologies would obscure the gist of the present disclosure obscure, the detailed description thereof has been. In addition, it should be appreciated that the accompanying drawings are provided merely for the sake of enhancing understanding of the embodiments set forth herein, and the technical idea of the present disclosure is not limited to the accompanying drawings. Rather, the present disclosure includes all modifications, equivalents, or alternatives falling within the spirit and scope of the present disclosure.

Terms including an ordinal number such as “a first” and “a second” may be used to describe various elements, but the elements are not limited to the terms. These terms are used merely for the purpose of distinguishing one element from other elements.

In the case where an element is referred to as being “connected” or “coupled” to any other elements, it should be understood that not only the element may be directly connected or coupled to the other elements, but also one or more other elements may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

A unit or a control unit included in names such as a motor control unit (MCU) and a hybrid control unit (HCU) is merely a term widely used for naming a controller configured to control a specific function of a vehicle, but does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to perform determination, calculation, decision or the like which are required for responsible function controlling.

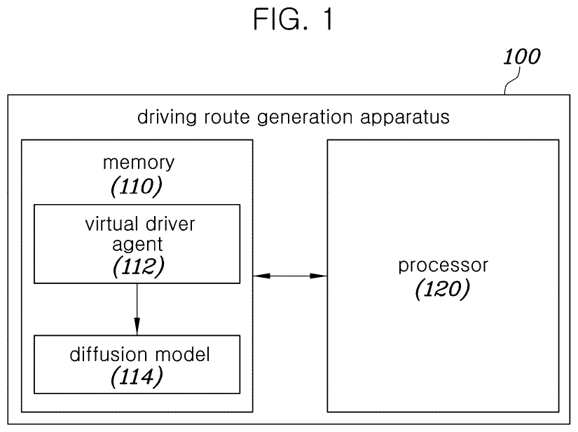

FIG. 1 is a block diagram illustrating a configuration of a driving route generation apparatus according to an embodiment of the present disclosure.

Referring to FIG. 1, a driving route generation apparatus 100 may include a memory 110 and a processor 120.

The memory 110 may include various types of storage devices such as a flash memory, hard disks, and SD cards, and may include a non-volatile memory such as a ROM, EEPROM, PROM, magnetic memory, or optical discs, or a volatile memory such as a RAM or SRAM.

The memory 110 may store one or more artificial intelligence models that enable the driving route generation apparatus 100 to generate driving data. For example, in an embodiment of the present disclosure, the memory 110 may store a virtual driver agent 112 and a diffusion model 114.

The processor 120 may be configured as at least one piece of specialized hardware such as a Neural Processing Unit (NPU) for processing artificial intelligence models, an AI processor, an application processor, a Field Programmable Gate Array (FPGA), or an Application-Specific Integrated Circuit (ASIC), but is not limited thereto.

The processor 120 may perform computations to enable driving data to be generated in the driving route generation apparatus 100. For example, the processor 120 may perform computations (e.g., complex computations) to train one or more artificial intelligence models stored in the memory 110 and generate driving data using the trained artificial intelligence models.

The virtual driver agent 112 may include a reinforcement learning-based training algorithm. Reinforcement learning is a technique in which an agent interacts with an environment to learn an optimal policy. In an embodiment of the present disclosure, the virtual driver agent 112 may learn a policy to improve rewards while interacting with the environment.

In an embodiment, the environment may indicate the driving route segments including the driving route segments of the driving data to be finally generated by the driving route generation apparatus 100. For example, when generating driving data for an arbitrary track (circuit), the driving route segment may indicate a specific corner of the track and a certain route segment before and after the corner, and the driving route segments may indicate the route segments of the track corresponding to one lap. A policy refers to a rule or strategy that enables the agent to select an optimal action in a given situation, and the policy, in an embodiment of the present disclosure, may include information about the actions to be taken by the virtual driver agent 112 in response to each driving situation. A reward is feedback received from the environment after the agent takes an action, and may be a value that evaluates how good or bad the action was. In an embodiment of the present disclosure, the reward may be determined based on Equation 1 below.

$${r}_{t} = \{ \begin{matrix}- c & ( if crashed ) \\ - ( {e}_{θ} {p}_{θ} + {e}_{c} {p}_{c} ) + {Δθ}_{t} & ( otherwise )\end{matrix} \qquad [ Equation 1 ]$$

In Equation 1, c is a predetermined constant, e_{θ} is the distance from the current location of the virtual driver agent 112 to the current target point determined according to the policy based on the current situation, pe is a weight for the value e_{θ}, e_{c} is the vertical distance between the location after the virtual driver agent 112 performs an action according to the policy and the centerline of the road including the driving route, p_{c} is a weight for the value e_{c}, and Δθₜ is the distance by which the virtual driver agent 112 travels from the reference location to the target location, where the travelled distance may be positive based on the vehicle moving forward and negative based on the vehicle moving backward in the reference coordinate system. c, p_{θ}, and p_{c} correspond to hyperparameters, and may be arbitrarily configured before the training of the virtual driver agent 112 begins. e_{θ}, e_{c}, and Δθₜ may be calculated or otherwise determined at every step by the processor 120 during the training process of the virtual driver agent 112.

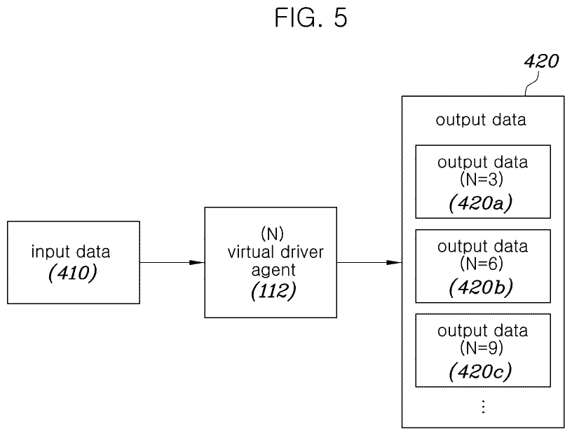

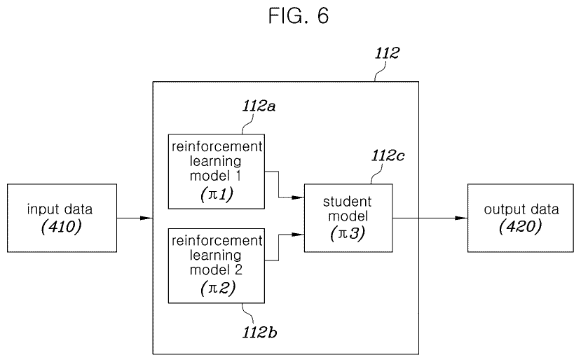

In an embodiment of the present disclosure, the processor 120 may receive the distances to the boundaries of the driving road or obstacles determined by the vehicle's sensors, and the location, speed, angular velocity, and steering angle of the vehicle, and may process the same using the trained virtual driver agent 112 to generate a distribution of driving routes for respective driving levels. The driving level may be determined based on the driver's handling ability, acceleration and deceleration control capability, cornering technique, drifting or traction control capability, the shape of the racing line, vehicle launch speed, and road surface condition of the driving route segment, for example. However, the present disclosure is not limited thereto. An example method for generating driving data corresponding to each driving level, according to an embodiment, is described in more detail below with reference to FIGS. 5 and 6.

The information about the driving route distribution for respective driving levels generated by the processor 120 using the trained virtual driver agent 112 may be a multi-dimensional vector in the form of a matrix corresponding to a plurality of actions performed in various driving situations. In an embodiment of the present disclosure, the information about the driving route distribution for respective driving levels may be a two-dimensional matrix vector, which may include information suggesting actions corresponding to respective situations.

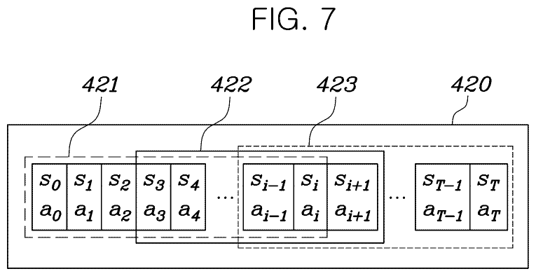

The diffusion model 114 may learn the distribution of driving routes for respective driving levels generated as described above. Before learning, the diffusion model 114 may perform a process of dividing information about the distribution of driving routes for respective driving levels, which is training data, using a sliding window technique. The sliding window technique continuously processes a predetermined range of information while moving a fixed-size window over the data. A method of processing training data using the sliding technique by the diffusion model 114, according to an embodiment, is described in more detail below with reference to FIG. 7.

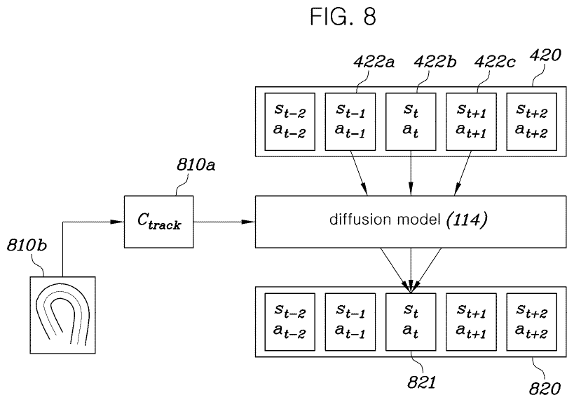

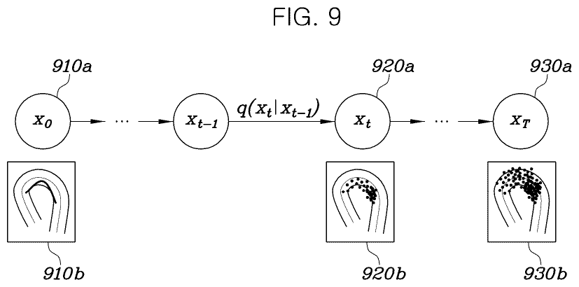

The diffusion model 114 may sequentially learn the information about the distribution of driving routes for respective driving levels divided through the sliding technique above. The diffusion model 114 may include an artificial intelligence model including a forward diffusion process of progressively adding noise to data samples, and a reverse diffusion process of restoring the original data by removing the added noise. The forward diffusion process is a process of progressively adding noise to the training data such that the original data changes to converge on a specific probability distribution. This process may progressively add noise such that the data converges according to a pre-defined probability distribution, which may be performed over a plurality of time steps. After the forward diffusion process is completed, the neural network receives an input of the forward-diffused data and is trained to restore the original data. For example, the neural network included in the diffusion model 114 is trained as a model of predicting the data before the addition of noise, based on the data derived through the forward diffusion process. The neural network performs training based on a loss function, calculates the difference between the actual noise added in the forward diffusion process and the added noise distribution predicted by the neural network, and optimizes weights of the neural network model to minimize the difference. The diffusion model 114, using the neural network trained as described above, may progressively remove noise through the reverse diffusion process, thereby restoring the original data. The forward diffusion process and reverse diffusion process of the diffusion model 114, according to embodiments, are described in more detail below with reference to FIGS. 8 and 9.

The processor 120, using the trained diffusion model 114, may receive information about the route segment where driving data is to be generated and the initial noise corresponding to the length of the driving data to be generated, and may generate driving data of the same length as the initial noise. In an embodiment, only the reverse diffusion process may be performed in the process of generating the driving data.

The diffusion model 114 may include a classifier (not shown). The classifier may be an artificial intelligence model or algorithm that analyzes input data and classifies it into predefined categories. In an embodiment of the present disclosure, the classifier may use gradients of a pre-trained neural network in order to adjust or convert the driving data generated by the trained diffusion model 114 into human-drivable data. For example, the classifier may add gradients of the pre-trained neural network to the mean of the noise distribution predicted during the reverse diffusion process of the trained diffusion model 114, and the trained diffusion model 114 may remove noise from the input data, based on the noise distribution with the added gradients. The gradients of the pre-trained neural network may be added at each step of removing the noise so that the classifier may derive output data belonging to a defined category as intended. However, such a classification method of the classifier is only an example and the present disclosure is not limited thereto. The classifier may operate as a guidance function of generating feedback on the driving data generated by the trained diffusion model 114.

The processor 120 may receive, as input, information about a plurality of predetermined waypoints to be passed within the route segment where the driving data is to be generated, and may generate driving data, based on the plurality of predetermined waypoints. The waypoint may be, within the route segment where the driving data is to be generated, one of an entry waypoint of the driving route, an apex waypoint indicating a turning point where the driving direction changes on the driving route, or an exit waypoint indicating the end point of the driving route, for example. However, the present disclosure is not limited thereto. The driving route of the driving data generated by the processor 120 may show various cornering lines depending on the locations where the waypoints are specified. For example, if the driving route segment where the driving data is to be generated has a hairpin corner structure, the driving route, indicating a cornering pattern corresponding to one of an in-out-in course driving, out-in-out course driving, or in-in-in course driving, may be generated depending on the waypoint locations input to the processor 120.

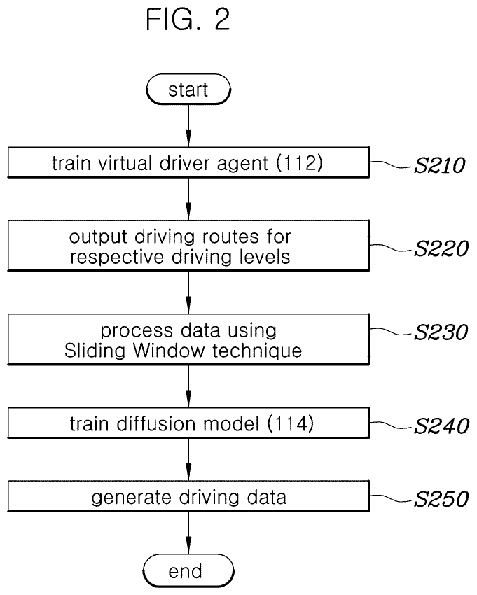

FIG. 2 illustrates an example of a process in which a driving route generation apparatus 100 generates driving data according to an embodiment of the present disclosure.

Referring to FIG. 2, in an operation S210, the virtual driver agent 112 stored in the memory 110 may be trained by the processor 120. In an embodiment, the processor 120 may receive driving route segments including the driving route segment where driving data is to be finally generated and train the virtual driver agent 112 to improve the reward by allowing the virtual driver agent 112 to interact with the received driving route segment. The reward may be calculated by the processor 120 according to Equation 1.

In an operation S220, the processor 120 may receive the distances to the boundaries of the driving road or obstacles determined by the vehicle's sensors, and the location, speed, angular velocity, and steering angle of the vehicle, and, based on this, generate a driving route distribution for respective driving levels using the trained virtual driver agent 112.

In an operation S230, the diffusion model 114 may preprocess the information about the driving route distribution for respective driving levels generated as described above using a sliding window technique before training. The respective pieces of preprocessed information about the driving route distribution for respective driving levels may have the same size, and the number of pieces of information after division may vary depending on the size of the data before division and the size of the separated data.

In an operation S240, the diffusion model 114 may learn the respective pieces of divided information about the driving route distribution for respective driving levels. By learning the respective pieces of divided information, the diffusion model 114 may prevent overfitting to the training data and learn driving routes with various trajectories. The diffusion model 114 may also receive information about a driving route segment of interest before learning and learn the training data, based on the received driving route segment.

In an operation S250, The processor 120 may receive, as input, information about the driving route segment where the driving data is to be generated, initial noise corresponding to the length of the driving data, and a plurality of waypoints, and may generate driving data using the diffusion model 114 trained as described above. The process of generating the driving data using the trained diffusion model 114 by the processor 120 includes performing of a reverse diffusion process. The trained diffusion model 114, at each step of removing noise during the reverse diffusion process, may remove noise, based on the noise distribution added with the gradients of a pre-trained neural network, using a classifier. The driving data generated through the above process may be adjusted or converted into human-drivable data.

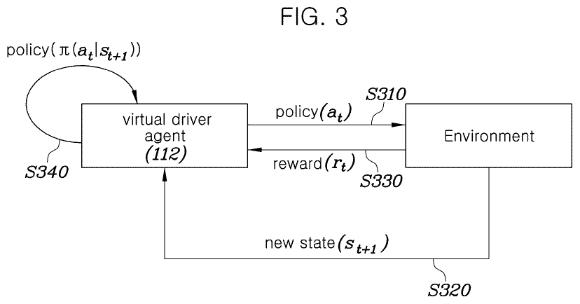

FIG. 3 illustrates an example of a process in which a virtual driver agent 112 is trained according to an embodiment of the present disclosure.

Referring to FIG. 3, in an operation S310, the virtual driver agent 112 may perform an action aₜ, based on the policy π(aₜ|sₜ) in the current situation sₜ. The action at according to the current situation sₜ is generally determined by a previously trained policy π(aₜ|sₜ), but it may also be probabilistically redefined. For example, the action according to the current situation may be determined through a process of attempting new actions with the potential to yield higher rewards from the environment or an exploration process of considering the possibility that the currently trained policy may not yield optimal actions. Examples of such exploration strategies include the Epsilon-Greedy method, Softmax method, and Policy Gradient method, but are not limited thereto.

The environment (e.g., a processor) may receive the action at performed by the virtual driver agent 112 and may define a new subsequent state according to a state transition function, based on the received action at. In an operation S320, the environment may transmit information about the new subsequent state sₜ₊₁ to the virtual driver agent 112.

The environment may also evaluate the action at received from the virtual driver agent 112 while transmitting the new state sₜ₊₁ and transmit a reward rt representing the same as a numerical value in an operation S330. The training performance of the reinforcement learning model and the manner of achieving a goal may vary depending on the design of a function for determining rewards. For example, the method of determining rewards may include a binary reward in which a value of +1 is assigned when a specific condition is satisfied and a value of 0 or −1 is assigned otherwise, and a continuous reward in which the reward is given as a continuous value depending on the quality of the performed action, but it is not limited thereto, and in an embodiment of the present disclosure, the reward may be defined by Equation 1 above.

In an operation S340, the virtual driver agent 112 may update the policy to a new policy π(aₜ|sₜ₊₁) through the new state sₜ₊₁ and the reward rt received. The new policy n (aₜ|sₜ₊₁) may be updated to improve the expected reward rₜ₊₁. The method for updating the policy may include Q-learning and policy gradient methods, but is not limited thereto.

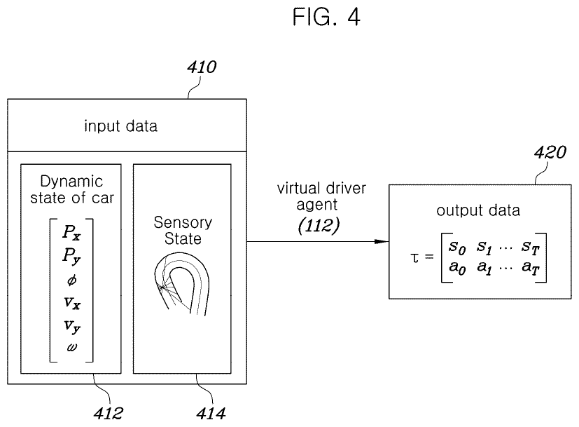

FIG. 4 illustrates an example of a form of data 410 input to a trained virtual driver agent 112 and a form of data 420 output based thereon according to an embodiment of the present disclosure.

Referring to FIG. 4, the input data 410 to the trained virtual driver agent 112 may include information about the dynamic state of car 412 and information about the sensory state 414 detected by the vehicle's sensors.

The information 412 on the dynamic state of car may include the location (p), steering angle (δ), speed (v), and angular velocity (w) of the vehicle. In an embodiment of the present disclosure, the location and speed of the vehicle may be represented separately by x- and y-coordinates from a top-view image of the driving route segment, but are not limited thereto, and may also be interpreted using other dimensional coordinate systems.

The information 414 on the sensory state detected by the vehicle's sensors may include the distances to the boundaries of the driving road or obstacles detected by the vehicle's sensors. For example, referring to the image corresponding to the information 414 on the sensory state detected by the vehicle's sensors shown in FIG. 4, the information 414 on the sensory state detected by the vehicle's sensors may include information about distances corresponding to multiple lines extending from the vehicle to the road boundaries.

The output data 420 generated from the input data 410 by the virtual driver agent 112 may be a vector in the form of a two-dimensional matrix corresponding to a plurality of actions a₀, a₁, . . . , and aₜ performed for respective driving situations s₀, s₁, . . . , and sₜ. For example, s₀ may indicate the 0^{th} situation, a₀ may indicate an action performed by the vehicle in s₀. Consequently, the output data 420 may include information about the actions for t situations.

FIGS. 5 and 6 illustrate a method for generating driving data corresponding to a driving level in an embodiment of the present disclosure.

FIGS. 5 and 6 provide different methods from each other, each being an example only, and the methods for generating driving data for respective driving levels are not limited thereto.

Referring to FIG. 5, the virtual driver agent 112 may be trained N times. In an embodiment, the training process of the reinforcement learning model may include, as described in FIG. 3, steps or operations in which the agent interacts with the environment, performs actions in specific situations, receives rewards and updated environment information according thereto, and updates the policy, based on the same. When this series of steps or operations is completed, one training cycle is considered to have been performed. As the number of training cycles increases, the policy may become optimized or overfitted. Policy optimization may indicate that the agent is able to suggest optimal actions for reaching the target point depending on driving situations. Therefore, when the agent performs actions based on the optimized policy, the lap time to reach the target point may be shorter than based on a non-optimized policy. In an embodiment of the present disclosure, the virtual driver agent 112 may be trained N times and, when input data 410 is received during the training process, may generate output data 420 corresponding thereto. A plurality of output data may be data generated based on the policy derived based on the number of times the virtual driver agent 112 has been trained at the time at which the input data 410 is received. For example, referring to FIG. 5, the respective output data 420a, 420b, and 420c may correspond to data generated at the time when the virtual driver agent 112 has been trained 3, 6, and 9 times, respectively, but the number of training cycles presented is merely illustrative and the present disclosure in not limited thereto. Since the level of policy optimization may vary depending on the number of training cycles, the driving routes presented by the respective output data 420a, 420b, and 420c may be different in lap time from each other. Therefore, when driving levels are classified based on lap time, the distribution of driving routes for respective driving levels may be derived from the plurality output data reflecting different lap times.

Referring to FIG. 6, the virtual driver agent 112 may include a plurality of reinforcement learning models 112a and 112b, and a student model 112c. A policy π1 trained by the reinforcement learning model 1 112a configured to follow the centerline may suggest actions that follow the centerline in each driving situation. A policy π2 trained by the high-speed-driving reinforcement learning model 2 112b may suggest actions that enables the agent to quickly reach the target point.

The rewards for respective reinforcement learning models 112a and 112b may be determined based on Equations 2 and 3 provided below.

$${r}_{t 1} = - 0.5 + {num}_{tile stepped} * ( \frac{max reward}{{num}_{total tile}} ) - 10 δ - {γ}_{center line} * \frac{{e}_{c}}{track width} \qquad [ Equation 2 ]$$

$${r}_{t 2} = - 0.5 + {num}_{tile stepped} * ( \frac{max reward}{{num}_{total tile}} ) * ( \frac{1 - Δ {e}_{c}}{track width} ) - 10 δ \qquad [ Equation 3 ]$$

In Equations 2 and 3, rₜ₁ is the reward of the reinforcement learning model 1, rₜ₂ is the reward of the reinforcement learning model 2, num_{total tile} is the total number of tiles into which the driving route segment corresponding to the environment learned by each reinforcement learning model 112a or 112b is divided based on a predetermined size, and num_{tile stepped} is the number of tiles stepped on by the agent according to the action performed under the current policy. The number of tiles may be determined based on a predetermined tile size within the driving route segment corresponding to the training environment. max reward is the maximum cumulative reward obtainable when the agent reaches the target point in each of the reinforcement learning models 112a or 112b, track width is the width of the driving route segment corresponding to the environment, e_{c} is the vertical distance from the current location to the centerline, γ_{center line} is a weight for

$$\frac{{e}_{c}}{track width} ,$$

and δ is a Dirac-delta function that may assign penalty of −10 when the agent moves beyond a predetermined distance in the forward curve direction.

The student model 112c may learn the plurality of trained policies π1 and π2. For example, the student model 112c may begin with a random or small-scale neural network at the early stage of training. The student model 112c may output the same situation-specific action distribution πₛ(a|s) in the same environment as the reinforcement learning model 1 112a and the reinforcement learning model 2 112b. For example, the student model 112c may calculate the Kullback-Leibler divergence between each of the trained policies π1 and π2 and the policy πₛ(a|s) of the student model and may be trained to minimize the loss function. The loss function may be calculated according to Equation 4 below.

$$L = {\sum }_{i = 1}^{N} {w}_{i} {\sum }_{a} {π}_{{T}_{i}} ( a \vert s ) log \frac{{π}_{{T}_{i}} ( a \vert s )}{{π}_{S} ( a \vert s )} \qquad [ Equation 4 ]$$

In Equation 4, L may be the loss function, N may be the number of trained policies, wᵢ may be the weight of each trained policy, π_{T}_{ᵢ}(a|s) may be the trained policy, and πₛ(a|s) may be the policy of the student model 112c. The expression

$${\sum }_{a} {π}_{{T}_{i}} ( a \vert s ) log \frac{{π}_{{T}_{i}} ( a \vert s )}{{π}_{S} ( a \vert s )}$$

may be the Kullback-Leibler divergence.

The student model 112c may update the weights wᵢ of the neural network so as to minimize the Kullback-Leibler divergence loss calculated above. The student model 112c may perform this process repeatedly and integratedly learn the plurality of trained policies π1 and π2.

The policy π3 derived by the trained student model 112c may be dynamically adjusted depending on the driving situation to assign higher weights to better performance of the policy among the pre-trained policies π1 and π2. Accordingly, the driving data 420 output based on the policy π3 derived by the trained student model 112c may include data containing not only driving routes that follow the centerline and high-speed driving routes, but also various other driving routes. The driving levels may be classified depending on which of the centerline-following route or the high-speed driving route is given a higher weight.

FIG. 7 illustrates example of a form in which 7 information about the distribution of driving routes for respective driving levels is divided using a sliding window technique according to an embodiment of the present disclosure.

Referring to FIG. 7, the data 420 output from the trained virtual driver agent 112 may be divided into partial data of a predetermined size before being trained by the diffusion model 114. The respective pieces of divided data 421, 422, and 423 may have the same size and include information corresponding to actions for driving situations overlapping each other.

The diffusion model 114 may learn the respective pieces of divided data 421, 422, and 423 to learn patterns for specific route segments from the distribution of driving routes for respective driving levels, which is the data before division, and to prevent overfitting to specific driving routes. Additionally, by reducing the size of the training data through the sliding window technique, the diffusion model 114 may improve computational efficiency during training by the processor 120.

FIG. 8 illustrates training data learned during training of a diffusion model 114 and data restored based thereon according to an embodiment of the present disclosure.

The diffusion model 114 may receive information 810a about the driving route where driving data is to be generated before training, and may learn the training data 420, based on the same. The information 810a about the driving route may include information 810b representing the type of corner in the form of a top-view image, but is not limited thereto. The information 810a about the driving route may include data on the shape of the driving route segment, the presence or absence of obstacles in the driving route segment, and road surface conditions within the driving route segment.

Referring to FIG. 8, the diffusion model 114 may learn only the (t−1)^{th} data 422a, the t^{th} data 422b, and the (t+1)^{th} data 422c among the training data 420. As described in FIG. 5, the training data 420 may be divided using the sliding window technique, and the diffusion model 114 may sequentially train the respective pieces of divided data. Therefore, the respective pieces of training data 422a, 422b, and 422c shown in FIG. 8 may be regarded as being included in the data 422 divided by the sliding window technique.

The diffusion model 114 may perform a forward diffusion process and a reverse diffusion process using the divided training data 422a, 422b, and 422c. The data 821 generated by the trained diffusion model 114 may be similar to one piece of the training data 422a, 422b, and 422c.

FIG. 9 illustrates an example of a forward diffusion process during training of a diffusion model 114 according to an embodiment of the present disclosure.

The forward diffusion process is a process of progressively adding Gaussian noise over a predetermined number of steps until the original data has distribution close to pure Gaussian noise. This process may be represented by Equation 5 below.

q(xₜ|xₜ₋₁)= [symbol] (xₜ;\sqrt{1−βₜ}xₜ₋₁,βₜI) [Equation 5]

In Equation 5, q(xₜ|xₜ₋₁) is the probability distribution changing from the sample xₜ₋₁ at step t−1 to the sample xₜ at step t, which is a probabilistic rule for adding Gaussian noise. [symbol] (μ; Σ) is a Gaussian distribution centered at the mean vector μ, where the spread of the data and the correlation among variables are determined by the added covariance matrix Σ. In [symbol] (xₜ; \sqrt{1−βₜ}xₜ₋₁, βₜI), the mean vector μ indicates that the sample xₜ at step t is obtained by multiplying the sample xₜ₋₁ at step t−1 by \sqrt{1−βₜ}, and the covariance matrix Σ, represented as βₜI, is formed by multiplying the identity matrix I by the noise strength βₜ changed at time the, which implies that independent noise corresponding to βₜI is added to each dimension.

Referring to FIG. 9, in an embodiment of the present disclosure, x₀ 910a, which corresponds to the original data, is the data divided by the sliding window technique, it may represent only a portion of the driving route, as shown in the corresponding image 910b. Subsequently, as shown in the image 920b corresponding to xₜ 920a, which is the data to which noise has been added t times, it may be confirmed that noise has been added around the driving route. Finally, in the image 930b corresponding to x_{T} 930a, which is the data to which noise has been added T times, it may be seen that noise has been added to such an extent that the driving route corresponding to x₀ 910a is no longer recognizable. The noise strength βₜ added at each step may vary, and the distribution of data 910a, 920a, and 930a at each step may differ depending on the added noise.

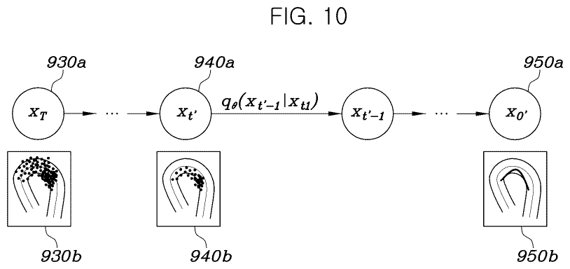

The diffusion model 114 performs a reverse diffusion process using x_{T} 930a. A reverse diffusion process, according to an embodiment, is described in more detail below with reference to FIG. 10.

FIG. 10 illustrates an example of a reverse diffusion process during training of a diffusion model 114 according to an embodiment of the present disclosure.

The reverse diffusion process is a process of progressively remove noise from the final noisy data to generate a sample similar to the original data. In the reverse diffusion process, the probability distribution q(xₜ₋₁|xₜ) for restoring the previous state data cannot be directly obtained, and the diffusion model 114 may train a neural network that predicts the added noise distribution and obtain the probability distribution in the reverse diffusion process using the trained neural network. In an embodiment, the neural network, that serves as a noise prediction model, is trained in order to derive the probability distribution for restoring the previous state data in the reverse diffusion process. The neural network corresponding to the noise prediction model may be trained using noise samples generated in the forward diffusion process. The neural network may be trained from the noise samples using a loss function to minimize the difference between the actual noise added at each noise addition step in the forward diffusion process and the noise predicted by the neural network model. In an embodiment of the present disclosure, although the loss function may be mean squared error (MSE), it is not limited thereto. The neural network may be trained using gradient descent in order to minimize the loss.

The trained neural network may be defined as e_{θ}(xₜ, t), and the probability distribution in the reverse diffusion process may be defined as shown in Equation 6 below.

p_{θ}(xₜ₋₁|xₜ)= [symbol] (xₜ₋₁;μ_{θ}(xₜ,t),Σ_{θ}(xₜ,t)) [Equation 6]

In Equation 6, p_{θ}(xₜ₋₁|xₜ) may represent the reverse diffusion probability distribution, μ_{θ}(xₜ,t) may denote the mean of the (t−1)^{th} data predicted by the neural network, and Σ_{θ}(xₜ,t) may denote the covariance predicted by the neural network. μ_{θ}(xₜ,t) may be further defined as shown in Equation 7 below.

$${μ}_{θ} ( {x}_{t} , t ) = \frac{1}{\sqrt{{α}_{t}}} ( {x}_{t} - \frac{{β}_{t}}{\sqrt{1 - \overline{{α}_{t}}}} {e}_{θ} ( {x}_{t} , t ) ) \qquad [ Equation 7 ]$$

In Equation 7, xₜ may indicate the data sample of the t^{th} state, βₜ may indicate the noise strength, αₜ may indicate the retention rate of the data as noise is added, α̅ₜ̅ may indicate the retention rate of the original data up to time t in the forward diffusion process, and e_{θ} (xₜ,t) may indicate the noise predicted by the trained neural network.

The data after noise is removed in the reverse diffusion process may be defined as shown in Equation 8 below.

xₜ₋₁=μ_{θ}(xₜ,t)+σtz [Equation 8]

In Equation 8, μ_{θ}(xₜ,t) may denote the mean of the (t−1)^{th} data predicted by the neural network, σₜ may denote the standard deviation of the noise, and z may denote a Gaussian noise sample.

Therefore, in the reverse diffusion process, the trained neural network e_{θ}(xₜ,t) may be used to approximate the reverse diffusion probability distribution p_{θ}(xₜ₋₁|xₜ).

Referring to FIG. 10, in an embodiment of the present disclosure, the reverse diffusion process of the diffusion model 114 may progressively remove noise from x_{T} 930a, which is the final data derived through the forward diffusion process, based on the reverse diffusion probability distribution obtained by the pre-trained neural network. Then, the data from which noise has been removed (T−t′) times is xₜ, 940a, and it may be confirmed from the corresponding image 940b that noise was reduced, so that the shape of the driving route is visible. It may be confirmed that x_{0″} 950a obtained by removing noise T times shows that the noise has been completely removed, as shown in the corresponding image 950b. It may be confirmed that this data represents substantially the same driving route as the original data x₀ 910a in FIG. 9.

In an embodiment of the present disclosure, the diffusion model 114 may perform learning without initial conditions in the training of the neural network, but it is not limited thereto.

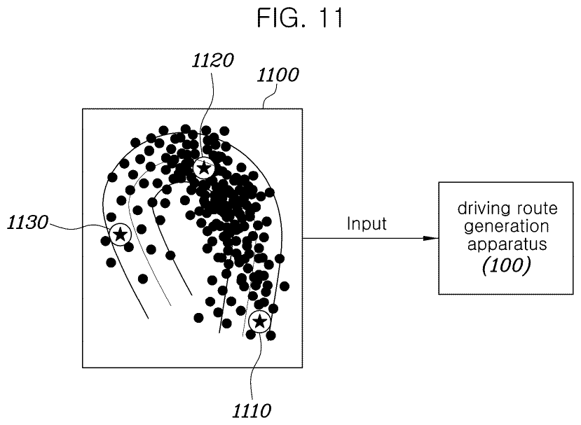

FIG. 11 illustrates an example of a form of data 1100 input to a driving route generation apparatus 100 according to an embodiment of the present disclosure.

Referring to FIG. 11, the input data 1100 may include information about the route segment where driving data is to be generated, a plurality of waypoints to be passed within the driving route segment, and initial noise. The information about the route segment where driving data is to be generated may include the shape of the driving route segment, the presence or absence of obstacles, and the like. There may be one or more waypoints. In an embodiment of the present disclosure, the input data 1100 may include information indicating that the driving route segment has a U-shaped structure and information indicating that there are a total of three waypoints 1110, 1120, and 1130. In an embodiment, the waypoints are arbitrarily specified, and the trajectory of the driving route in the generated driving data may vary depending on the specified locations.

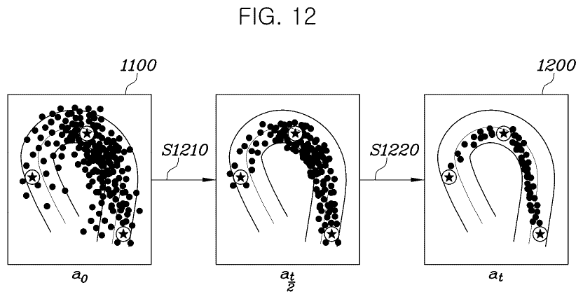

FIG. 12 illustrates an example of a process of generating driving data according to an embodiment of the present disclosure.

Referring to FIG. 12, a processor 120 may generate driving data 1200 by performing a reverse diffusion process with respect to the input data 1100 using the trained diffusion model 114. In an operation S1210, if noise is removed for

$$\frac{t}{2}$$

time, noise around the driving route may be removed while maintaining the driving route passing through the specified waypoints. If noise is removed for t time, a driving route from which noise is completely removed may be generated in an operation S1220. In an embodiment, t may be large or small depending on the distribution of the initial noise and the reverse diffusion probability distribution learned by the diffusion model 114.

According to the embodiments described above, the driving data generated by the driving route generation apparatus 100 may reflect driving routes having various driving trajectories for respective driving levels.

The present disclosure as described above may be implemented as computer-readable codes in a medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense, but should be considered in an illustrative sense in all aspects. The scope of the present disclosure shall be determined by reasonable interpretation of the appended claims, and all changes and modifications within an equivalent range of the present disclosure fall within the scope of the present disclosure.

What is claimed is:

1. A driving route generation device comprising:
a memory configured to store a virtual driver agent and a diffusion model; and
a processor configured to:
train the virtual driver agent to output driving routes respectively corresponding to pre-defined driving levels for a given road,
train the diffusion model based on distribution of the driving routes for respective driving levels output by the trained virtual driver agent,
input information related to a route segment of a road where driving data is to be generated, information related to a plurality of pre-configured waypoints to be passed within the route segment, and initial noise corresponding to a length of the driving data to the trained diffusion model, and
generate, using the trained diffusion model, driving data corresponding to the length.

2. The driving route generation device of claim 1, wherein the virtual driver agent comprises a training algorithm based on reinforcement learning, wherein the training algorithm is configured to train a policy such that the virtual driver agent improves a reward while interacting with the road.

3. The driving route generation device of claim 2, wherein the virtual driver agent is configured to determine the reward based on
$${r}_{t} = \{ \begin{matrix}- c & ( if crashed ) \\ - ( {e}_{θ} {p}_{θ} + {e}_{c} {p}_{c} ) + {Δθ}_{t} & ( otherwise )\end{matrix} ,$$
wherein:
c is a predetermined constant,
e_{θ} is a distance from a current location of the virtual driver agent to a current target point configured according to a policy determined through the training algorithm,
p_{θ} is a weight for a value of e_{θ},
e_{c} is a vertical distance between a location after the virtual driver agent performs an action according to the policy determined through the training algorithm and a centerline of the road,
p_{c} is a weight for a value of e_{c}, and
Δθₜ is a distance by which the virtual driver agent travels from a reference location to a target location, wherein the distance has a positive value based on a vehicle moving forward and a negative value based on a vehicle moving backward in a reference coordinate system.

4. The driving route generation device of claim 2, wherein the policy is configured to determine actions to be performed by the virtual driver agent for respective driving situations.

5. The driving route generation device of claim 1, wherein the trained virtual driver agent is configured to:
receive, as an input, distances to boundaries of a driving road or obstacles determined by sensors provided in a vehicle and a location, speed, angular velocity, and steering angle of the vehicle; and
output the distribution of the driving routes determined for respective driving levels based on the input.

6. The driving route generation device of claim 1, wherein the distribution of the driving routes for respective driving levels is a multi-dimensional vector in a form of a matrix corresponding to a plurality of actions performed by the trained virtual driver agent for respective driving situations.

7. The driving route generation device of claim 1, wherein the diffusion model is configured to:
divide information about the distribution of the driving routes for respective driving levels into partial data of a certain size using a sliding window technique; and
learn the partial data.

8. The driving route generation device of claim 1, wherein the diffusion model is configured to:
learn the distribution of the driving routes for respective driving levels without initial conditions; and
perform denoising and data restoration through forward and reverse diffusion processes.

9. The driving route generation device of claim 1, wherein the diffusion model further comprises a classifier configured to use gradients of a pre-trained neural network to convert driving data output by the diffusion model into human-drivable data, wherein the classifier is configured to operate as a guidance function of generating feedback for output driving data of the diffusion model.

10. The driving route generation device of claim 1, wherein the plurality of pre-configured waypoints includes one or more of an entry waypoint of a driving route within the route segment, an apex waypoint indicating a turning point where a driving direction changes on the driving route, or an exit waypoint indicating an end point of the driving route.

11. A method for generating driving routes, the method comprising:
training, by a processor, a virtual driver agent to output driving routes respectively corresponding to pre-defined driving levels;
training, by the processor, a diffusion model, based on distribution of the driving routes for respective driving levels output by the trained virtual driver agent; and
inputting, by the processor, information related to a route segment of a road where driving data is to be generated, information related to a plurality of pre-configured waypoints to be passed within the route segment, and initial noise corresponding to a length of the driving data to the trained diffusion model; and
generating, by the processor, using the trained diffusion model, driving data corresponding to the length.

12. The method of claim 11, wherein:
the virtual driver agent comprises a training algorithm based on reinforcement learning; and
training the virtual driver agent includes training the training algorithm based on a policy such that the virtual driver agent improves a reward while interacting with the road.

13. The method of claim 12, wherein training the virtual driver agent includes determining the reward based on
$${r}_{t} = \{ \begin{matrix}- c & ( if crashed ) \\ - ( {e}_{θ} {p}_{θ} + {e}_{c} {p}_{c} ) + {Δθ}_{t} & ( otherwise )\end{matrix} ,$$
wherein:
c is a predetermined constant,
e_{θ} is a distance from a current location of the virtual driver agent to a current target point configured according to a policy determined through the training algorithm,
p_{θ} is a weight for a value of e_{θ},
e_{c} is a vertical distance between a location after the virtual driver agent performs an action according to the policy determined through the training algorithm and a centerline of the road,
p_{c} is a weight for a value of e_{c}, and Δθₜ is a distance by which the virtual driver agent travels from a reference location to a target location, wherein the distance has a positive value based on a vehicle moving forward and a negative value based on a vehicle moving backward.

14. The method of claim 12, wherein the policy is configured to determine actions to be performed by the virtual driver agent for respective driving situations.

15. The method of claim 11, further comprising:
inputting, by the processor, to the trained virtual driver agent, distances to boundaries of a driving road or obstacles determined by sensors provided in a vehicle and a location, speed, angular velocity, and steering angle of the vehicle to obtain distribution of the driving routes for respective driving levels; and
outputting, by the processor, the distribution of the driving routes obtained for respective driving levels.

16. The method of claim 11, wherein the distribution of the driving routes for respective driving levels is a multi-dimensional vector in a form of a matrix corresponding to a plurality of actions performed by the trained virtual driver agent for respective driving situations.

17. The method of claim 11, wherein training the diffusion model includes:
dividing information related to the distribution of the driving routes for respective driving levels into partial data of a certain size using a sliding window technique; and
training the diffusion model based on the partial data.

18. The method of claim 11, wherein training the diffusion model includes training the diffusion model based on the distribution of the driving routes for respective driving levels without initial conditions, including performing denoising and data restoration through forward and reverse diffusion processes.

19. The method of claim 11, further comprising converting, by a classifier of the diffusion model using gradients of a pre-trained neural network, driving data output by the diffusion model into human-drivable data, wherein the classifier is configured to operate as a guidance function of generating feedback for output driving data of the diffusion model.

20. The method of claim 11, wherein the plurality of pre-configured waypoints includes one or more of an entry waypoint of the driving route within the route segment, an apex waypoint indicating a turning point where a driving direction changes on the driving route, or an exit waypoint indicating an end point of the driving route.
